(19) United States
(12) Patent Application Publication
(10) Pub. No.: US 2010/0132418 A1
(43) Pub. Date: Jun. 3, 2010

(54) IMPACT RESISTANT ELECTRONIC LOCK

(76) Inventor: Shixiong Chen, (US)

Correspondence Address: SHIXIONG CHEN, 15 LAUREL BLUFF CT., COLUMBIA, SC, 29229, US

(21) Appl. No.: 12/324,994

(22) Filed: Nov. 28, 2008

(51) Int. Cl. E05B 47/00

(52) U.S. Cl. 70/277

(57) ABSTRACT

An electronically controlled solenoid lock mechanism that remains locked when subjected to an impact type force. The lock utilizes the kinetic energy of a sliding bar during an impact to push on a lever with a fixed fulcrum such that the opposite end of the lever pushes against the core of the solenoid to keep it engaged with a latching mechanism. This prevents the unintentional opening a device to which the lock is attached with a mechanism that is energy, weight and cost efficient.

### TECHNICAL FIELD OF THE INVENTION

The present invention relates to electronic locks. More specifically, the present invention relates to an improved solenoid lock mechanism. The lock mechanism is capable of remaining locked when it is subjected to an impact force.

### BACKGROUND OF THE INVENTION

Electronically controlled solenoid locks are becoming an increasingly popular choice for locking portable devices such as portable safes, gun boxes, and briefcases to make opening and closing these devices more convenient through the use electronic keys, pin pads or biometric sensors.

Solenoid locks typically employ a common electromagnetic solenoid with a return spring. In the de-energized state the spring forces the core into the locked position through a latch mechanism. When the coil is energized, the magnetic force generated by the coil forces the core to compress the return spring, releasing the latch mechanism and opening the lock.

Advantages of this type of locking system are that opening and closing the lock can be achieved very quickly and the cost of this simple structure is relatively low compared with other electronic locking methods. The disadvantage of this type of system, especially when used for portable devices, is that the weight of the solenoid core can overcome the return spring force when the core is subjected to an impact load along its axis, such as that caused by dropping or banging the portable device against a hard surface. This situation could occur by accident or when a person is intentionally tampering with the portable device. When the return spring force is overcome by the kinetic energy of the core, the portable device can open unexpectedly spilling the contents or allowing a thief to take the contents.

Previous attempts have been made in the art to overcome this significant disadvantage of solenoid locks. One obvious solution would be to make the solenoid spring stronger in order to overcome the kinetic energy of the core during an impact. However, the increase in spring force required to overcome the kinetic energy of the core would require a larger electromagnetic coil and consume considerably more power, causing an increase in the size, weight, and cost of the system. Obviously, none of these is desirable for a portable consumer device.

Another solution to the problem has been to spring bias the core perpendicular to its axis. This solution also has the effect of increasing the power, weight, and size requirements. Additionally, it increases the complexity of the system by adding components.

Yet another solution involves the use of an elaborate mechanism requiring movement of multiple parts in perpendicular planes. This solution also dramatically increases the complexity, weight, size, and cost of the system.

While the above solutions may work in theory, none are practical for use in portable consumer devices. As such, a need exists for a compact, reliable, energy efficient, and low cost solenoid lock mechanism for portable devices capable of withstanding impact forces.

### BRIEF SUMMARY OF THE INVENTION

Objects and advantages of the invention will be set forth in part in the following description, or may be obvious from the description, or may be learned through practice of the invention.

In the primary embodiment, the present invention is generally directed to a solenoid lock mechanism comprising the following elements: an electromagnetic solenoid with a cylindrical collar on a cylindrical core and a return spring to push the core to an extended position, a substantially cylindrical bar with a cylindrical collar that is substantially the same weight as the solenoid core, a lever with a fixed central pivot, and a moveable latch mechanism. In one embodiment, the solenoid is mounted in a fixed position on the fixed part of a lock mechanism, such that when it retracts the core moves to the right. The cylindrical bar is slidably mounted such that its longitudinal axis is in a plane substantially parallel to the longitudinal axis of the solenoid core. The bar is supported at two points by a fixed guide, where the support points are located towards the end of each bar. The collar on the bar is positioned between the two fixed guide support points, which are a fixed part of the lock mechanism. This arrangement prevents the bar from sliding completely through the holes in the fixed guide in either direction. The lever is mounted on a substantially central fixed fulcrum, where the fulcrum is fixed at a substantially central location between the solenoid and the bar. The lever is constructed so that one end is long enough to make contact with the collar on the core and the other end can contact the end face of the bar closest to the solenoid. However, the lever is not connected to either the bar or the solenoid and is free to pivot about the fulcrum until it contacts either the end of the bar or the core collar. In the de-energized state, the return spring constantly pushes the core of the solenoid through a hole in the latch mechanism, which is a moveable part of the lock. When the solenoid is energized, the core retracts through the hole in the latch and compresses the return spring, thus allowing the portable device to be opened. Assuming the lever is touching the core collar, as the core retracts, the collar on the core pushes the lever around the fulcrum and slides the bar to the left. When the solenoid is again de-energized, the return spring forces the core back through the latch to lock the portable device, but there may be no movement of the either the bar or the lever during this operation as there is no force on either the lever or the bar. It is this feature that creates the impact resistance of the lock without requiring extra power, since the solenoid does not have to overcome excessive spring force or excessive friction from a complex mechanism in order to prevent the lock from opening. If a portable device containing the lock mechanism is dropped, banged or otherwise impacted in a manner that causes the core to move against the return spring toward the retracted position, the collar will contact the lever and begin rotating the lever toward the end of the bar. Since the bar has substantially the same weight as the core, the kinetic energy of the bar will be substantially the same as the core during the impact. However, since the bar will be moving in the same direction as the core, the bar will contact the lever before the core retracts through the hole in the latch, because the bar does not have to overcome the resisting force of the return spring. The force exerted on the lever by the bar pushes the lever back against the collar on the core with a force sufficient to keep the core engaged with the hole in the latch, preventing accidental opening. Thus this solenoid lock mechanism solves the problem of impact resistance with a simple mechanical system that is energy, weight and cost efficient.

Additional objects and advantages of the present subject matter are set forth in, or will be apparent to, those of ordinary skill in the art from the detailed description herein. Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which includes and makes reference to the appended figures, in which:

FIG. 1 is a cross section view of an exemplary embodiment of the impact resistant solenoid lock in a locked position according to the present invention;

FIG. 2 is a cross section of the exemplary embodiment of FIG. 1 in the unlocked position;

Repeat use of reference characters throughout the present specification and appended drawings is intended to represent the same or analogous features or elements of the invention.

### DETAILED DESCRIPTION

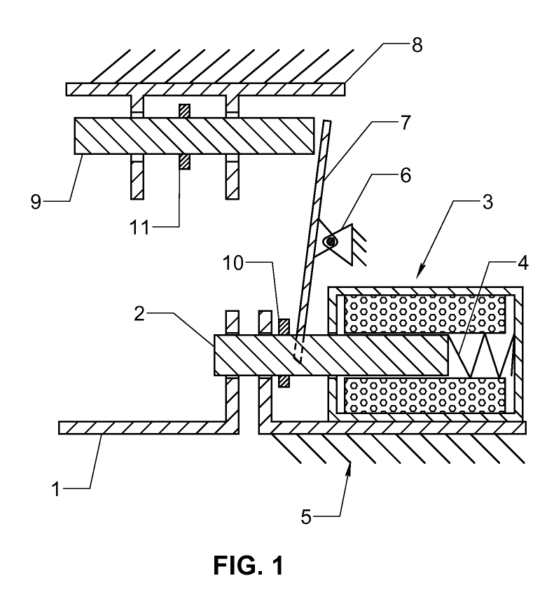

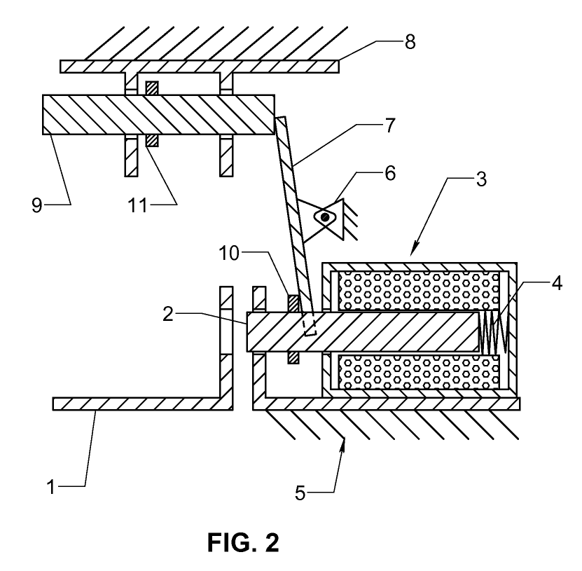

The present application generally provides for an impact resistant solenoid lock. In order to fully understand the advantages of the present disclosure, FIGS. 1-2 will be explained in greater detail as exemplary embodiments of the present invention. Each example is provided by way of explanation of the invention, and not meant as a limitation of the invention. For example, features illustrated or described as part of one embodiment may be used with another embodiment to yield still a further embodiment. In fact, it will be apparent to those skilled in the art that various modifications and variations can be made in the present invention without departing from the scope or spirit of the invention.

As shown in the exemplary embodiment depicted in FIG. 1, the electronically controlled impact resistant solenoid lock mechanism is comprised of a latch 1 that is a moveable part of the lock mechanism, a fixed part of the lock mechanism 5, a ferrous solenoid core 2 with collar 10, electromagnetic solenoid 3, and return spring 4. In addition, fixed guide 8 supports bar 9 with collar I1 and lever 7 is attached to fixed fulcrum 6. Guide 8 slidably supports bar 9, where the longitudinal axis of bar 9 is substantially parallel to the longitudinal axis of core 2. Lever 7 is of a length such that it extends to the centerline of an end face of bar 9 in one direction, and it extends to the centerline of core 2 in the other direction. However, lever 7 is not fixably attached to either bar 9 or core 2. Bar 9 can slide freely between the two points of support offered by guide 8 until collar 11 makes contact with a part of guide 8. The potential length of travel in bar 9 is greater than or equal to the length of travel in core 2. Fulcrum 6 is fixed in a position between bar 9 and core 2, such that when collar 10 and bar 9 contacts lever 7, core 2 still protrudes through the hole in latch 1.

In the exemplary embodiment depicted in FIG. 1, the solenoid 3 is in the de-energized state and the return spring 4 forces the core 2 through a circular hole in the latch 1 to indicate a locked status. If the device containing the lock mechanism is subjected to an impact force along the longitudinal axis of core 2 towards the return spring 4, such as that caused by striking the device against a hard surface, the core 2 would begin moving to compress the return spring until collar 10 on core 2 contacted the lever 7. At the same time, bar 9 would be moving in the same direction as core 2 until the end face of bar 9 contacted lever 7. Since core 2 and bar 9 have substantially the same weight, they essentially have the same kinetic energy at the time of impact. However, since there is no resistive spring force on bar 9, it will always reach lever 7 before collar 10. This is true even if the length of travel of bar 9 is at its maximum where collar 11 is touching the left support on guide 8. The force supplied to lever 7 by the kinetic energy of bar 9 will always be greater than that exerted on lever 7 by collar 10, thus keeping core 2 from retracting through the hole in latch 1 and keeping the lock in its locked position.

In the exemplary embodiment depicted in FIG. 2, the lock is shown in the unlocked position. During the unlocking operation, solenoid 3 is energized, creating an electromagnetic force that pulls core 2 in a direction that compresses return spring 4. As core 2 travels, collar 10 pushes against lever 7 causing it to rotate about fulcrum 6 and push against the end of bar 9. Since bar 9 can freely slide in the guide 8, the force required to slide bar 9 is minimal and can be easily generated by solenoid 3 as it retracts core 2. When the solenoid is de-energized, core 2 is again pushed back through latch 1 without requiring any movement of lever 7 or bar 9. Thus the mechanism has a negligible effect during normal operation of the lock and only activates when the lock experiences an impact type force.

While the present subject matter has been described in detail with respect to specific embodiments thereof, it will be appreciated that those skilled in the art, upon attaining and understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. An impact resistant solenoid lock mechanism comprising:
a. a moveable latch means,
b. a fixed, electronically controlled, electromagnetic solenoid containing a ferrous core with a collar means on said core and a return spring capable of exerting a force on said core,
c. a bar with a collar means capable of freely sliding between two fixed points,
d. a lever means with a fixed fulcrum mounted between said solenoid and said bar,
whereby the kinetic energy of said bar during an impact acts on said lever, which in turn, acts on said core to prevent disengagement of said latch.

2. A solenoid lock as in claim 1, wherein the longitudinal axis of said bar and said core are parallel.

3. A solenoid lock as in claim 1, wherein said fulcrum of said lever is fixed between said core and said bar, such that one end of said lever is capable of acting on one end face of said bar and the other end is capable of acting on said core collar.

4. A solenoid lock as in claim 1, where said bar is substantially cylindrical in shape and is substantially the same weight as said core.
